(19) United States
(12) Patent Application Publication
(10) Pub. No.: US 2015/0357837 A1
(43) Pub. Date: Dec. 10, 2015

(54) BATTERY CHARGER, BATTERY CHARGING SYSTEM, AND BATTERY CHARGING METHOD

(71) Applicants: Masami TAKAI, (US); Masaaki YOSHIDA, (US)

(72) Inventors: Masami Takai, Tokyo (JP); Masaaki YOSHIDA, Kanagawa (JP)

(73) Assignee: RICOH COMPANY, LTD., Tokyo (JP)

(21) Appl. No.: 14/655,873

(22) PCT Filed: Dec. 23, 2013
(86) PCT No.: PCT/JP2013/085356

§ 371 Date: Jun. 26, 2015

(30) Foreign Application Priority Data
Dec. 28, 2012 (JP) 2012-288016
Dec. 4, 2013 (JP) 2013-250923

(51) Int. Cl. H02J 7/00

(52) U.S. Cl. CPC H02J 7/007; H02J 7/0021

(57) ABSTRACT

A battery charger for charging a battery includes a charger; an acquisition unit acquiring information of the battery; and a control unit setting a charging condition of the battery based on the information of the battery and controlling the charger.

### TECHNICAL FIELD

The present invention relates to a battery charger.

### BACKGROUND ART

There have been known an electric motor and a two-wheeled electric vehicle driven using pedals. The two-wheeled electric vehicle is equipped with a battery as a power source of the electric motor of the two-wheeled electric vehicle. The battery may be charged by using a charger connected to a domestic AC power outlet or a charging facility installed at a bicycle-parking area or the like.

Further, there has been known an in-vehicle battery charger which includes two kinds of chargers having different charging rates from each other (see, for example, Patent Document 1).

### DISCLOSURE OF THE INVENTION

### Problems to be Solved by the Invention

There are various specifications available for the batteries that can be mounted in the two-wheeled electric vehicle. The characteristics of the batteries may vary depending on the difference in the specifications. Namely, the batteries that can be mounted in the two-wheeled electric vehicles may have different characteristics. Due to the difference in the characteristics of the batteries, it is desired to charge batteries in accordance with the specifications of the batteries.

Therefore, an object of the present invention is to provide a battery charger that may charge batteries in accordance with the characteristics of the batteries.

### Means for Solving the Problems

A disclosed battery charger for charging a battery includes a charger; an acquisition unit acquiring information of the battery; and a control unit setting a charging condition of the battery based on the information of the battery and controlling the charger.

### Effects of the Present Invention

According to a disclosed aspect of the present invention, it becomes possible to charge batteries in accordance with the characteristics of the batteries.

### BRIEF DESCRIPTION OF THE DRAWINGS

FIG. 1 is a drawing showing a diagram of a battery charging system according to an embodiment;

FIG. 2 is a functional block diagram of a battery charger according to an embodiment;

FIG. 3 is a functional block diagram of a charging rate setting section according to an embodiment;

FIG. 4 is a drawing showing a display of a control panel according to an embodiment;

FIG. 5 is a drawing showing a battery pack according to an embodiment;

FIG. 6 is a drawing showing specifications of the battery pack according to an embodiment;

FIG. 7 is a drawing showing an example of a battery charging time according to an embodiment;

FIG. 8 is a drawing showing necessary conditions to charge a battery in a certain time period;

FIG. 9 is a flowchart showing an operation of the battery charging system according to an embodiment;

FIGS. 10A and 10B are drawings showing information displayed on the control panel while the battery charging system is operated;

FIG. 11 is a drawing showing a setting of a charging rate when the battery charging system is operated;

FIG. 12 is a drawing showing an example of a charging rate setting according to an embodiment;

FIG. 13 is a drawing showing another example of the charging rate setting according to an embodiment;

FIG. 14 is a drawing showing still another example of the charging rate setting according to an embodiment;

FIG. 15 is a drawing showing an electric bicycle charging system according to an embodiment;

FIG. 16 is a drawing showing an example of charging schedule in the electric bicycle charging system; and

FIG. 17 is a drawing showing a modified example of the electric bicycle charging system.

### BEST MODE FOR CARRYING OUT THE INVENTION

Next, embodiments to carry out the present invention are described based on the following descriptions with reference to the accompanying drawings.

### First Embodiment

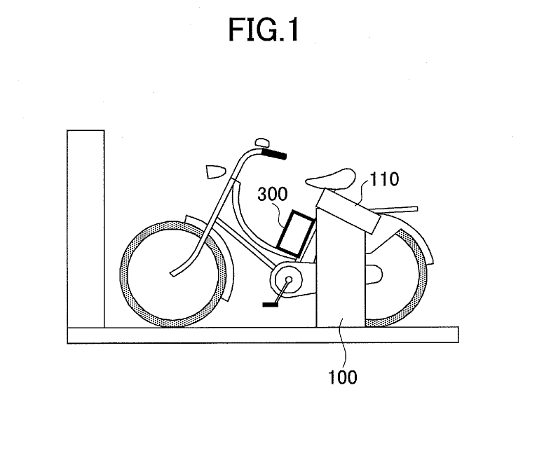

FIG. 1 is a drawing showing a diagram of a battery charging system according to an embodiment. The battery charging system charges a battery of a battery pack 300 mounted in an electric bicycle. Besides the electric bicycle, the battery charging system may also be applied to charge a battery of the battery pack that is mounted in an electrically-movable object (electrically movable body) such as an object including, but not limited to, a commuter object, a power-operated vehicle, and an electric motorcycle.

The battery charging system includes a battery charger 100. The battery of the battery pack 300 can be charged by connecting the battery charger 100 to the battery pack 300 mounted in the electric bicycle and operating a control panel 110 of the battery charger 100.

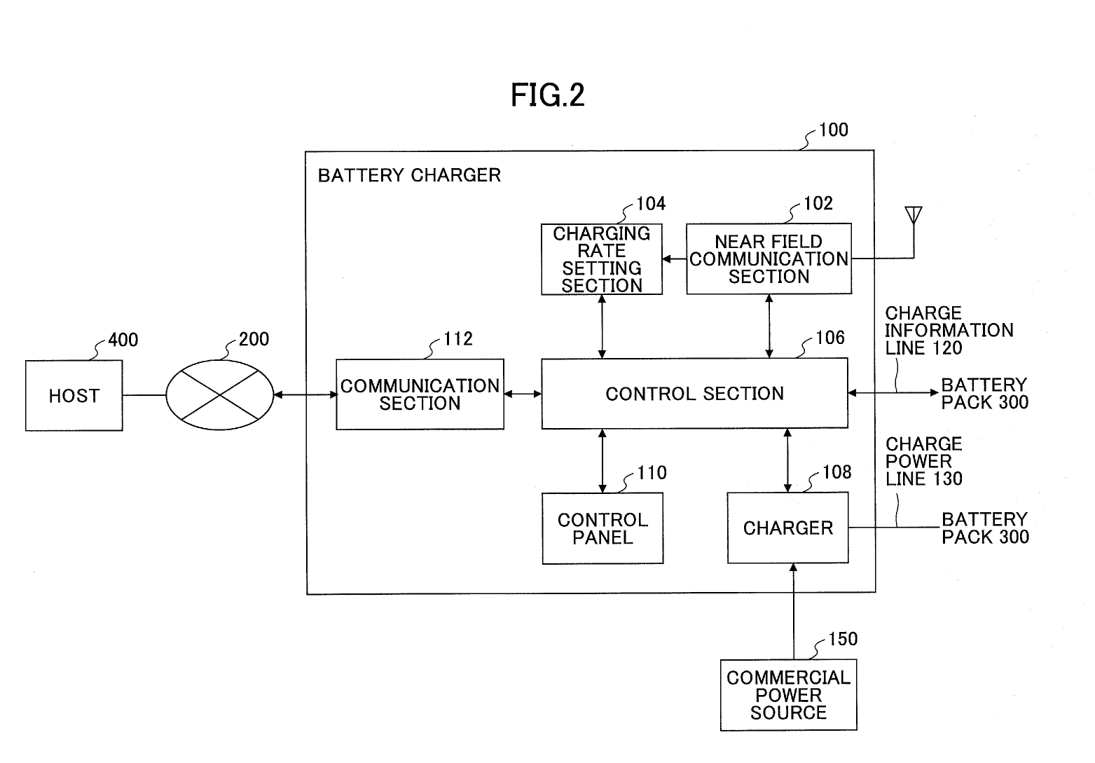

FIG. 2 is a functional block diagram of the battery charger 100 according to an embodiment.

As shown in FIG. 2, the battery charger 100 includes a near field communication section 102, a charging rate setting section 104, a control section 106, a charger 108, a control panel 110, and a communication section 112.

The near field communication section 102 performs wireless communications with the battery pack 300. To that end, the near field communication section 102 supports near field communication techniques such as, for example, IEEE802.15, Bluetooth (registered trademark), Zig Bee (registered trademark), Felica, TransferJet, Personal Area Network, and RFID. It is assumed that the battery charger 100 according to an embodiment uses the RFID. In this case, preferably, the near field communication section 102 includes a function of an RFID reader. The near field communication section 102 serves as an acquisition section that acquires tag information by receiving the tag information from an IC tag included in the battery pack 300. It is preferable that an authentication process be performed during the wireless communications between the near field communication section 102 and the IC tag. The tag information includes, for example, a manufacturer name of the battery pack 300, the product type name (model name), the ID number, the battery capacity value, and the overcharge voltage value. The near field communication section 102 transmits the tag information to the charging rate setting section 104 and the control section 106.

The near field communication section 102 may set at least a part of the tag information in advance, so as to compare the part of the tag information with the tag information from the IC tag. For example, it is desirable that the information such as the product type name of the battery pack 300 that can be charged by the battery charger 100 is registered in advance in the near field communication section 102. In this case, the near field communication section 102 transmits the tag information to the charging rate setting section 104 and the control section 106 when the product type name included in the tag information from the tag IC corresponds to any one of the registered product type names of the battery packs that can be charged by the battery charger 100. Further, it is further preferable that, when the product type name included in the tag information from the tag IC does not correspond to any one of the registered product type names of the battery packs that can be charged by the battery charger 100, the near field communication section 102 notifies the charging rate setting section 104 and the control section 106 of the fact that there is no product type name included in the tag information corresponding to any of the registered product type names.

Further, for example, it is more preferable that the tag information set in the near field communication section 102 includes information indicating which model(s) corresponding to the registered product type name supports “quick charging”. The “quick charging” herein refers to a function of the battery of the battery pack 300 capable of being charged at a charging rate higher (faster) than that of an IC. In this case, namely, when the product type name included in the tag information from the tag IC corresponds to any one of the registered product type names of the battery packs that supports quick charging to be charged by the battery charger 100, the near field communication section 102 transmits (inputs) the tag information to the charging rate setting section 104 and the control section 106. On the other hand, when the product type name included in the tag information from the tag IC does not correspond to any one of the registered product type names of the battery packs that supports quick charging to be charged by the battery charger 100, it is preferable that the near field communication section 102 notifies the control section 106 of the fact that there is no product type name included in the tag information that corresponds to any of the registered product type names.

The charging rate setting section 104 is connected to the near field communication section 102. Based on the tag information from the near field communication section 102, the charging rate setting section 104 sets a parameter to be used upon setting the charging rate.

### Charging Rate Setting Section 104

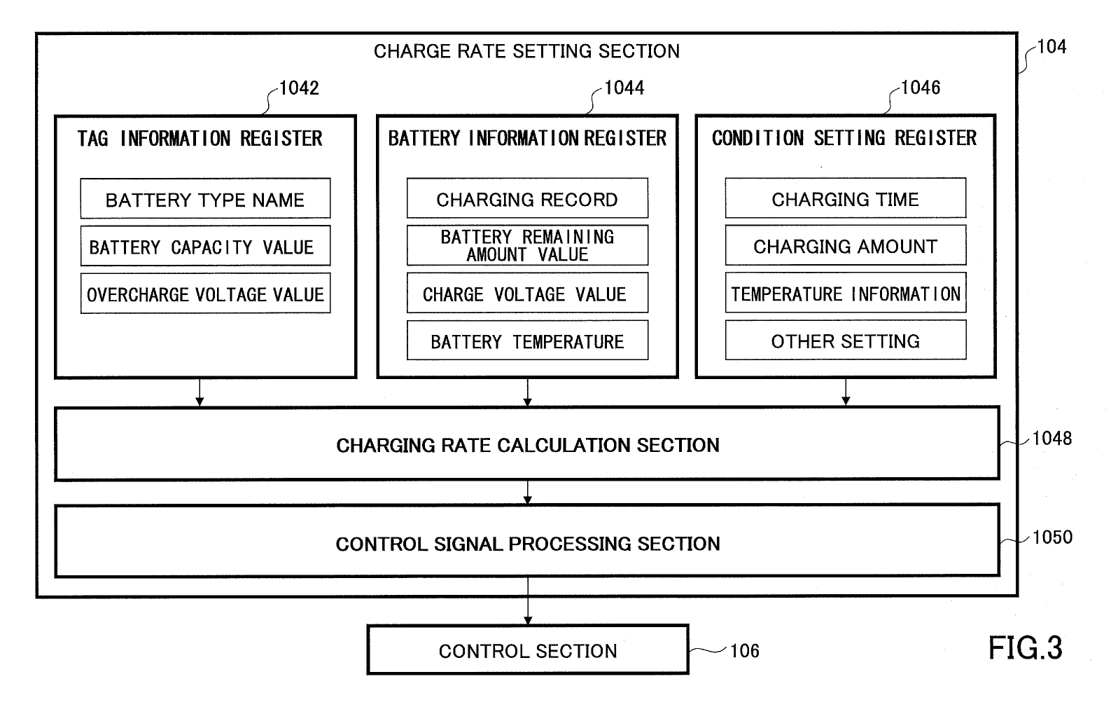

FIG. 3 is a functional block diagram of the charging rate setting section 104 according to an embodiment.

The charging rate setting section 104 includes a tag information register 1042, a battery information register 1044, a condition setting register 1046, a charging rate calculation section 1048, and a control signal processing section 1050.

The tag information register 1042 registers the tag information. More specifically, the tag information register 1042 registers the tag information input by (transmitted from) the near field communication section 102. It is preferable that the tag information register 1042 registers a battery type name (the product type name), the battery capacity value, and the overcharge voltage value included in the tag information. However, the tag information register 1042 may register the manufacturer name of the battery pack, the ID number and the like.

The battery information register 1044 registers battery information. The battery information register 1044 registers the information included in a charging record that is stored in the battery pack 300. More specifically, the battery information register 1044 registers charging date and time, a battery remaining amount and the like as the charging record.

The condition setting register 1046 registers conditions upon charging. More specifically, the condition setting register 1046 registers charging time and a charging amount. The charging time and the charging amount are input via the control panel 110. It is preferable that the condition setting register 1046 registers setting conditions including environmental setting information such as, for example, temperature information from a host 400.

The charging rate calculation section 1048 is connected to the tag information register 1042, the battery information register 1044, and the condition setting register 1046. The charging rate calculation section 1048 calculates the settable charging time and the charging amount based on the information registered in the tag information register 1042 and the information registered in the battery information register 1044. The charging rate calculation section 1048 associates the information registered in the tag information register 1042 and the information registered in the battery information register 1044 with the settable charging time and the charging amount in advance. The charging rate calculation section 1048 transmits (inputs) the information indicating the settable charging time and the charging amount to the control signal processing section 1050.

Further, the charging rate calculation section 1048 calculates the charging rate when the battery is charged using the charger 108 based on the charging time and the charging amount which are selected by the user. More specifically, it is preferable that the charging rate calculation section 1048 calculates a “C rate”. The charging rate calculation section 1048 inputs the “C rate” into the control signal processing section 1050.

The “C rate” is used to indicate charging rate characteristics of a battery. Here, the term “1 C” refers to a rate at which a battery is charged up to a predetermined voltage in one hour. Therefore, if the charging time is 3.3 hours, the C rate is calculated as 0.3 (= 1/3.3) The current in this case is determined based on the battery capacity value of the battery.

The “C rate”, however, is an example only. Namely, any charging rate other than the “C rate” may alternatively be used.

The control signal processing section 1050 is connected to the charging rate calculation section 1048. The control signal processing section 1050 inputs the information (control signal) indicating settable charging time and the charging amount into the control section 106.

Further, the control signal processing section 1050 inputs the control signal including the C rate into the control section 106.

Referring back to FIG. 2, the description is continued.

The control section 106 is connected to the charging rate setting section 104. The control section 106 is connected to the battery pack 300 via an I/F (not shown) with a charge information line 120. The control section 106 inputs (receives), for example, the charging record (charging record information) of the battery pack 300 from the battery pack 300.

The control section 106 registers information into the battery information register 1044 of the charging rate setting section 104, the information being included in the charging record information from the battery pack 300.

Based on the control information from the charging rate setting section 104, the control section 106 controls the charger 108. The control section 106 controls the charger 108 based on the C rate included in the control information from the charging rate setting section 104. By controlling the charger 108 with the control section 106, the battery of the battery pack 300 is charged using a charge power line 130.

When the control section 106 receives a notice from the near field communication section 102, the notice indicating that there is no chargeable product type name corresponding to any one of the product type names included in the tag information of the IC tag, the control section 106 issues an instruction to the control panel 110 to display that it is not possible to charge.

When the control section 106 receives a notice from the near field communication section 102, the notice indicating that there is no the chargeable product type name of the battery that can be quickly charged corresponding to any one of the product type names included in the tag information of the IC tag, the control section 106 issues an instruction to the control panel 110 to display that it is not possible to quickly charge.

The charger 108 is connected to the control section 106. Further, the charger 108 is connected to the battery pack 300 via the charge power line 130. The charger 108 charges a battery 306 of the battery pack 300 based on the control of the control section 106. According to one embodiment, the charger 108 may charge a battery having a greater charging rate. Specifically, the charger 108 may charge a battery having a greater charging rate which corresponds to 1 C or less or 1 C or more, for example, in a range from approximately 2 C to approximately 20 C.

The communication section 112 is connected to the control section 106. The communication section 112 communicates with the host 400 via a network 200. For example, the host 400 may report (notify) the information indicating the chargeable battery pack 300 to the battery charger 100. By doing this, it becomes possible to update the information of the chargeable battery pack 300 registered in the battery charger 100.

Further, for example, the host 400 may notify the battery charger 100 of the battery pack 300 that supports the “quick charging”. By doing this, it becomes possible to update the information of the battery pack supporting the “quick charging” and being registered in the battery charger 100.

The control panel 110 is connected to the control section 106. The control panel 110 is used by the user to input a charging condition when the two-wheeled electric vehicle is charged. The charging condition includes, for example, the charging time and the charging amount.

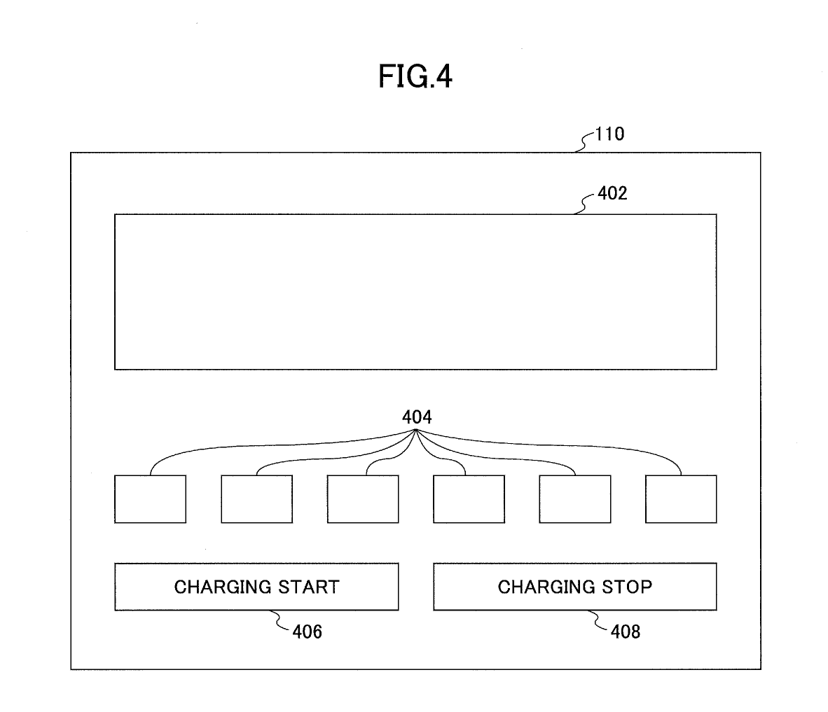

FIG. 4 is a drawing showing a display of the control panel 110 according to an embodiment.

The control panel 110 includes a display 402, charging condition setting buttons 404, a charging start switch 406, and a charging stop switch 408. The charging condition setting buttons 404, the charging start switch 406, and the charging stop switch 408 may be different buttons. Otherwise, the control panel 110 may include a touch panel so that the charging condition setting buttons 404, the charging start switch 406, and the charging stop switch 408 are provided on the touch panel.

The display 402 displays the information to be reported to the user. For example, the display 402 may display an operation status, an operating status and the like.

The charging condition setting buttons 404 are used to set conditions for charging. It is preferable that the charging time and the charging amount can be set by using the charging condition setting buttons 404. In the example of FIG. 4, there are six charging condition setting buttons 404. However, the number of the charging condition setting buttons 404 may be less than or greater than six.

When the charging time and the charging amount are set, the contents to be set by the charging condition setting buttons 404 may be displayed on the display 402. Here, it is preferable that the charging amount is displayed as a ratio relative to the full charged amount using, for example, “%”.

The charging start switch 406 is selected (operated) to start charging. It is preferable that the charging start switch 406 is pressed down.

The charging stop switch 408 is selected (operated) to stop charging. It is preferable that the charging stop switch 408 is pressed down.

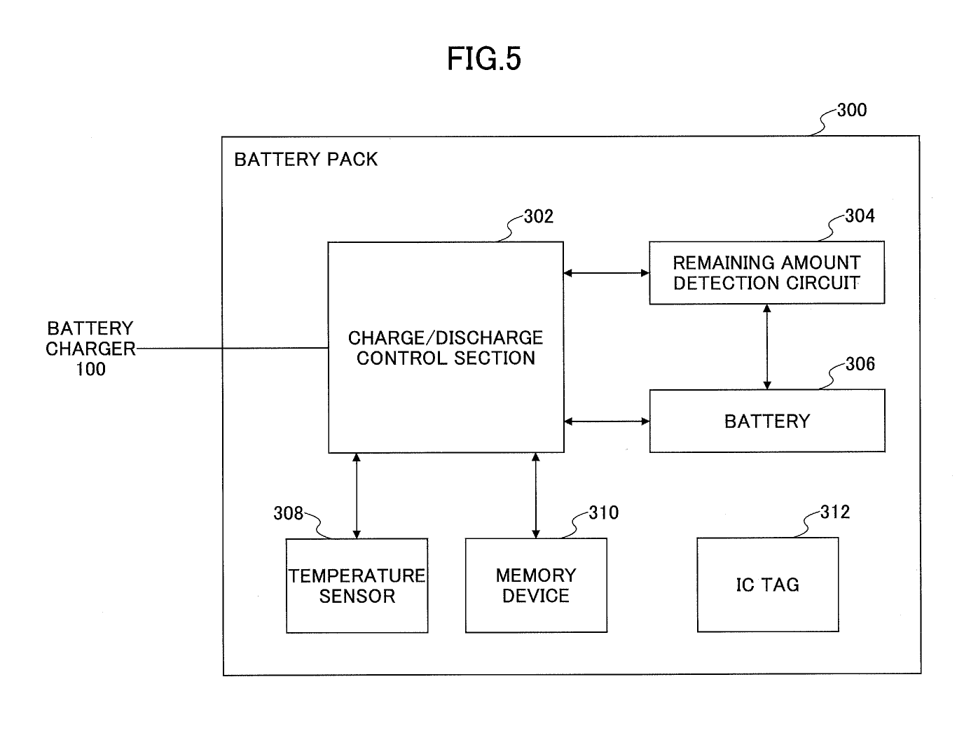

FIG. 5 is a drawing showing the battery pack 300 according to an embodiment. The battery pack 300 is mounted in the electric bicycle. It is preferable that the battery pack 300 is detachably mounted in the electric bicycle. The battery pack 300 may be charged while the battery pack 300 is detached from the electric bicycle. The battery pack 300 may be charged while the battery pack 300 is mounted in the electric bicycle.

The electric bicycle according to an embodiment includes the battery that supports the “quick charging”. For example, if the battery can be charged in a short period such as approximately ten minutes, it is preferable that the battery can be charged without removing the battery pack 300 from the electric bicycle every time. However, when the battery is charged in a facility such as home where a quick charger cannot be installed or until the quick charger becomes popular, it is preferable that the battery pack 300 is detachable from the electric bicycle.

The battery pack 300 includes a charge/discharge control section 302, a remaining amount detection circuit 304, the battery 306, a temperature sensor 308, a memory device 310, and an IC tag 312.

The charge/discharge control section 302 is connected to the battery charger 100 via an I/F (not shown). The functions of the charge/discharge control section 302 include a function to prevent heating, explosion and the like due to applying over charging voltage to the processor and the battery, a function to prevent overcurrent, a function to prevent over discharge, and a cell balance function. The functions are executed mainly by the processor (not shown). Namely, the functions of the charge/discharge control section 302 are executed by the processor based on an application stored in the memory device 310.

The charge/discharge control section 302 performs control of charging and discharging the battery 306. Upon the execution of the charging process of the battery 306, the charge/discharge control section 302 stores the charging record into the memory device 310. Specifically, it is preferable that the charge/discharge control section 302 stores the charging date and time and the battery remaining amount value as the charging record. The charge/discharge control section 302 inputs the battery remaining amount value from the remaining amount detection circuit 304, the temperature detected by the temperature sensor 308, and the charging record stored in the memory device 310 into the battery charger 100.

The remaining amount detection circuit 304 is connected to the charge/discharge control section 302. The remaining amount detection circuit 304 detects a remaining amount of power (energy) accumulated in the battery 306. The remaining amount detection circuit 304 inputs the detected remaining amount of power into the charge/discharge control section 302.

The battery 306 is connected to the charge/discharge control section 302 and the remaining amount detection circuit 304. The battery 306 accumulates (charges) power (energy) by being charged by the battery charger 100. The battery 306 according to an embodiment has a greater charging rate. For example, it is preferable that the charging rate of the battery 306 is greater than 1 C and approximately 20 C.

The temperature sensor 308 is connected to the charge/discharge control section 302. The temperature sensor 308 measures the temperature. The temperature measured by the temperature sensor 308 is reported to the battery charger 100, so that the battery charger 100 controls the charging rate based on the reported temperature. This is because it is assumed that the charging rate may vary depending on the temperature.

The memory device 310 is connected to the charge/discharge control section 302. The memory device 310 stores the charging record sent from the charge/discharge control section 302.

The IC tag 312 stores the information of the battery pack 300. Specifically, the IC tag 312 stores, for example, the manufacturer name of the battery pack 300, the product type name (model name), the ID number, the battery capacity value, and the overcharge voltage value. The IC tag 312 transmits the information of the battery pack 300 by performing wireless communications with the near field communication section 102 of the battery charger 100. Otherwise, the information stored in the IC tag 312 such as the manufacturer name of the battery pack 300, the product type name (model name), the ID number, the battery capacity value, and the overcharge voltage value may be transmitted to the charging rate setting section 104 and the control section 106 via the charge information line 120 which is a wired line connecting between the battery charger 100 and the battery pack 300. By doing this, it becomes possible to transmit the information stored in the IC tag 312 such as the manufacturer name of the battery pack 300, the product type name (model name), the ID number, the battery capacity value, and the overcharge voltage value to the battery charger 100 without mounting a wireless communication device into the battery charger 100 and the battery pack 300. Therefore, the cost may be reduced.

At least a part of the information stored in the IC tag 312 in advance may be set in the control section 106 so as to be compared with tag information from the battery pack 300. For example, it is preferable that the product type names of the batteries that can be charged by the battery charger 100 are registered in the control section 106. In this case, when any one of the product type names of the batteries, that can be charged by the battery charger 100 and are registered in the control section 106 corresponds to any one of the product type names included in the tag information from the battery pack 300, the control section 106 inputs the information stored in the IC tag 312 into the charging rate setting section 104 and the control section 106. On the other hand, when there is no product type name of the battery, that can be charged by the battery charger 100, registered in the control section 106 corresponding to any one of the product type names included in the tag information from the battery pack 300, the control section 106 causes the control panel 110 to display that it is not possible to perform rapid charging.

### Charging Rate Calculation Process

The charging rate calculation section 1048 calculates conditions for charging such as the charging time and the charging amount. The conditions for the charging are notified to the user. Specifically, the charging rate calculation section 1048 associates the charging time with the charging amount. More specifically, the charging rate calculation section 1048 associates the charging time with the charging amount based on the battery capacity value registered in the tag information register 1042, the battery remaining amount registered in the battery information register 1044, and the environmental setting information such as the temperature information previously set in the condition setting register 1046.

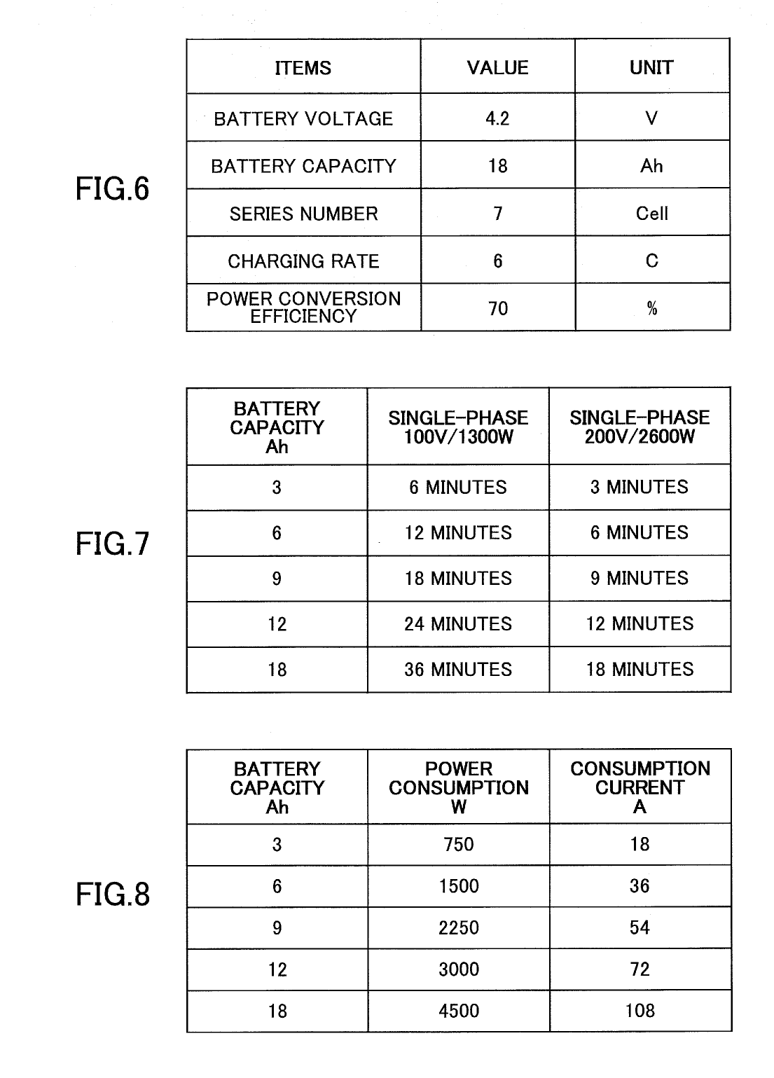

FIG. 6 is a drawing showing specifications of the battery pack 300 according to an embodiment.

In the specifications of the battery pack 300 according to an embodiment, the battery voltage is 4.2 V, the battery capacity is 18 Ah, the number of cells in series is 7, the charging rate is 6 C, and the power conversion efficiency is approximately 70%.

For example, a typical charging time of a conventional bicycle is more than two hours.

Here, energy (power) consumption is considered in a case where power (energy) is charged up to 80% in ten minutes (i.e. charging rate 6 C) into the battery whose the maximum battery capacity is 18 Ah.

The specifications of the battery pack 300 of FIG. 6 are described in the following formula (1).

4.2 V×18 Ah×7 cell÷70%×6 C [symbol] 4500 W (1)

Namely as shown in formula (1), the power consumption is expressed as “(battery voltage)×(battery capacity)×(number of cells in series)÷(power conversion efficiency)×(charging rate)”. According to formula (1), the power consumption is 4500 W, so that single-phase 100 V power source cannot be used. In this case, it is not possible to set that the charging time is 10 minutes and the charging rate is 6 C.

FIG. 7 is a drawing showing an example of a battery charging time according to an embodiment. FIG. 7 shows cases to charge the battery 306 of the battery pack 300 of FIG. 6.

As shown in FIG. 7, when a power source of single-phase 100 V/1300 Wh is used, the charging time is 6 minutes (when the battery capacity is 3 Ah), 12 minutes (6 Ah), 18 minutes (9 Ah), 24 minutes (12 Ah), and 36 minutes (18 Ah). When a power source of single-phase 200 V/2600 Wh is used, the charging time is 3 minutes (when the battery capacity is 3 Ah), 6 minutes (6 Ah), 9 minutes (9 Ah), 12 minutes (12 Ah), and 18 minutes (18 Ah).

Namely, when the power source of single-phase 100 V is used, the charging is finished in 6 through 36 minutes, and when the power source of single-phase 200 V is used, the charging is finished in 3 through 18 minutes.

When the charging time is approximately 30 minutes, the charging may be finished within a time period from when a user gets up and promptly starts charging by inserting the plug into the power outlet and until when the user leaves home.

In one embodiment of the battery charger 100, a case is described where the charger 108 is connected to the single-phase 100 V/1300 W commercial power source. This case is similar to the case where the charger 108 is connected to the single-phase 200 V/2600 W commercial power source. Further, the power source conditions may be changed and applied.

The charging rate calculation section 1048 calculates settable charging time and charging amount. For example, in one example of the charging time of FIG. 7, the battery can be fully charged in 36 minutes when the battery capacity is 18 Ah. Therefore, battery can be charged 25% in 9 minutes, 50% in 18 minutes, and 75% in 27 minutes. In this case, the charging rate calculation section 1048 acquires 9 minutes, 18 minutes, 28 minutes, and 36 minutes as the charging time and 25%, 50%, 75%, and 100% as the corresponding charging amounts. In view of the user's convenience, it is preferable to acquire the charging amounts corresponding to more comprehensive times such as 5 minutes, 10 minutes, 15 minutes, 20 minutes, 25 minutes, 30 minutes, and 35 minutes.

FIG. 8 is a drawing showing necessary power consumption and consumption current conditions to charge the battery 306 of the battery pack 300 of FIG. 6 in 10 minutes.

As shown in FIG. 8, when the battery capacity is 3 Ah, the power consumption is 750 W and the consumption current is 18 A; when the battery capacity is 6 Ah, the power consumption is 1500 W and the consumption current is 36 A; when the battery capacity is 9 Ah, the power consumption is 2200 W and the consumption current is 54 A; when the battery capacity is 12 Ah, the power consumption is 3000 W and the consumption current is 72 A; and when the battery capacity is 18 Ah, the power consumption is 4500 W and the consumption current is 108 A.

As shown in FIG. 8, in case of a high battery capacity type, the power consumption is 4500 W and the consumption current is 108 A.

In one embodiment of the battery charger 100, the charger 108 is connected to the commercial power source of single-phase 100 V/1300 Wh. Therefore, when the battery capacity is 3 Ah, it is possible to charge in 10 minutes.

The charging rate calculation section 1048 inputs the information indicating the settable charging time and the charging amount into the control signal processing section 1050. The control signal processing section 1050 inputs the information indicating the settable charging time and the charging amount into the control section 106. The control section 106 inputs the information indicating the settable charging time and the charging amount into the control panel 110. As a result, the settable charging time and the charging amount are displayed in the control panel 110.

The user may select the charging time and the charging amount by operating the control panel 110. By selecting the charging time and the charging amount by the user, the information indicating the selected charging time and the charging amount is input from the control section 106 into the charging rate setting section 104.

Based on the charging time and the charging amount selected from the control section 106, the charging rate calculation section 1048 calculates the charging rate. Based on the charging time and the charging amount from the control section 106, the charging rate calculation section 1048 calculates the C rate. The charging rate calculation section 1048 inputs the C rate into the control signal processing section 1050.

The control signal processing section 1050 generates a control signal including the C rate from the charging rate calculation section 1048, and inputs the control signal into the control section 106.

The control section 106 controls the charger 108 based on the control signal from the charging rate setting section 104.

### Operation of Battery Charging System

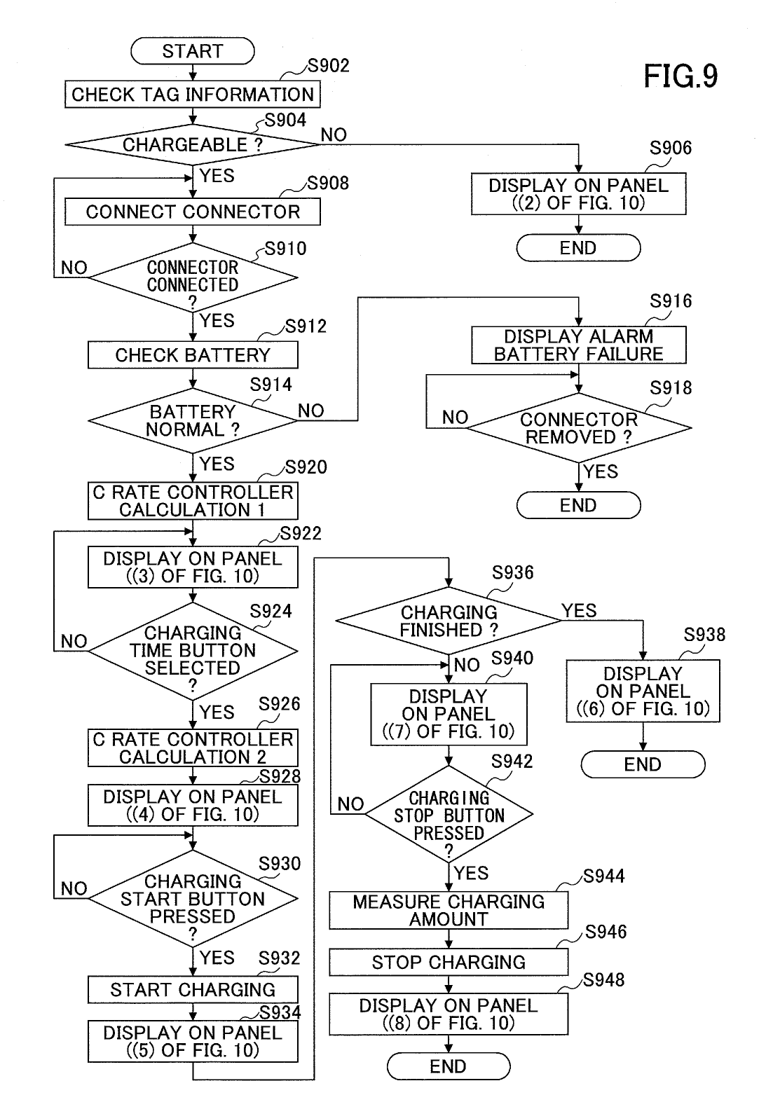

FIG. 9 is a flowchart showing an operation of the battery charging system according to an embodiment.

In one embodiment of the battery charging system, a case is described where charging is done using a charging stand (spot) installed in a large supermarket during 10 to 60 minute shopping. This case may also be applied to any other cases.

Here, a case is described where up to 80% of charging is done in 10 to 60 minutes. Namely, it is preferable that up to 80% of charging is done as the maximum value of the charging amount (MAX charging amount) in view of deterioration of the battery and simplification of the battery charger.

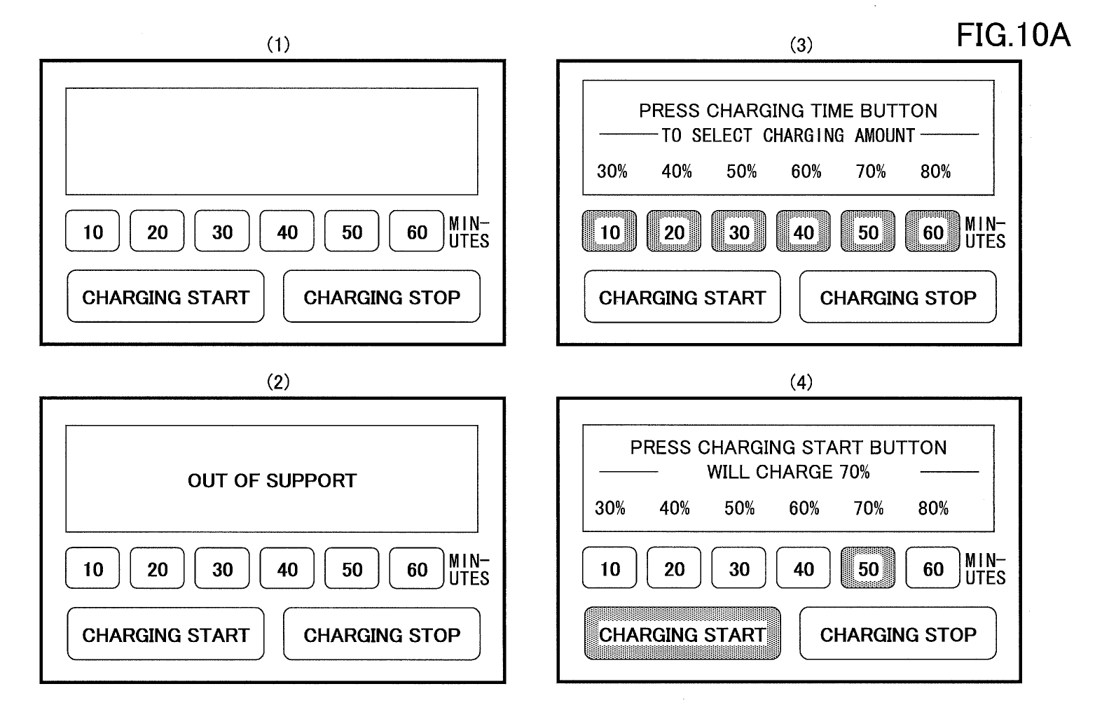

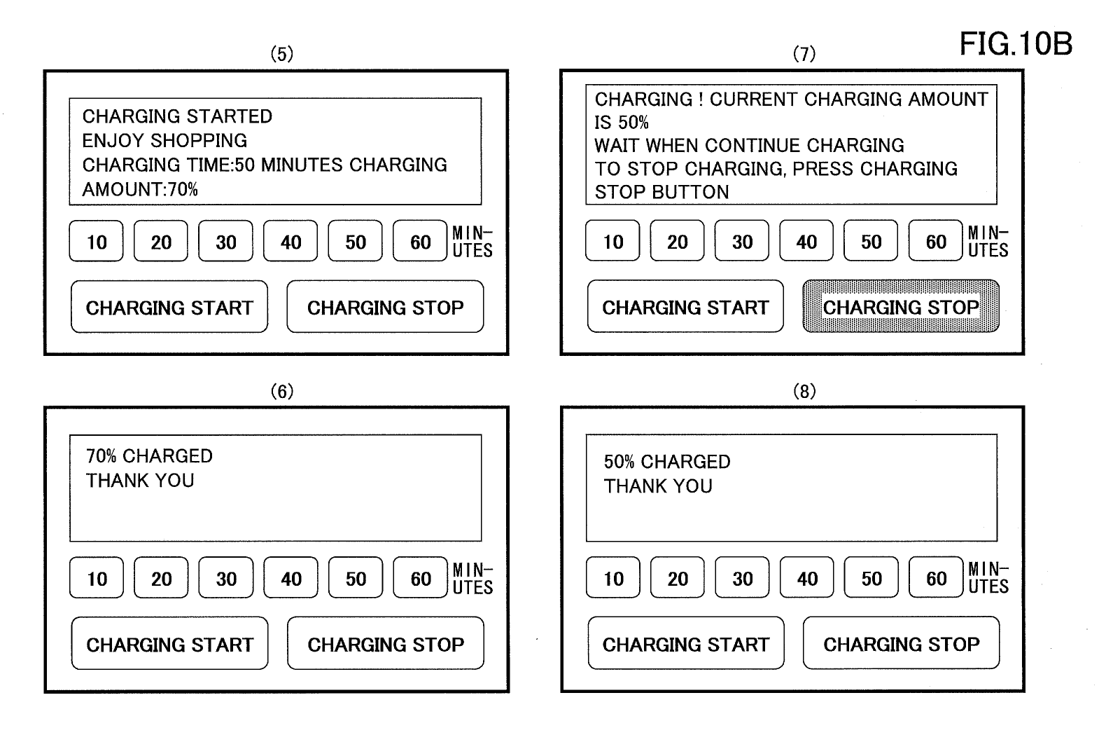

FIGS. 10A and 10B are drawings showing information displayed on the control panel while the battery charging system is operated.

Referring back to FIG. 9, the flowchart is described.

In step S902, the battery charger 100 checks the tag information. The near field communication section 102 of the battery charger 100 communicates with the IC tag 312 mounted in the battery pack 300 so as to check the information stored in the IC tag 312. Nothing is displayed on the control panel 110 as shown in part (1) of FIG. 10A.

In step S904, the battery charger 100 determines whether it is possible for the battery charger 100 to charge. The battery charger 100 compares the information previously registered with the tag information. The battery charger 100 determines that it is not possible to charge when the battery 306 of the battery pack 300 does not correspond to the battery charger 100. For example, when the battery type name of the batteries that can be charged by the battery charger 100 is not included in the battery type name included in the IC tag mounted in the battery pack 300, the battery charger 100 determines that it is not possible to charge.

Further, the battery charger 100 may determine that it is not possible to charge when the battery 306 of the battery pack 300 does not support the quick charging. For example, when the battery type name of the batteries that support the quick charging by the battery charger 100 is not included in the battery type name included in the IC tag mounted in the battery pack 300, the battery charger 100 may determine that it is not possible to perform the quick charging.

Further, the ID number of a battery which is stolen may be registered in the battery charger 100. In this case, it is determined that it is possible to charge when the ID number of the stolen battery does not correspond to the ID numbers included in the IC tag 312 mounted in the battery pack 300. Preferably, the ID number of the stolen battery is sent from the host 400 to the battery charger 100.

The IC tag 312 is mounted in the battery pack 300 so as to wirelessly communicate with the battery charger 100. Therefore, it becomes possible to report whether it is possible to charge before the battery pack 300 is connected to the battery charger 100.

In place of the wireless connection between the battery pack 300 and the battery charger 100, the battery pack 300 may be connected to the battery charger 100 using a cable to conduct the same procedure described above.

In step S906, when it is determined that it is not possible to charge in step S904, as shown in part (2) of FIG. 10A, the battery charger 100 causes the control panel 110 to display that it is not possible to correspond.

In step S908, when it is determined that it is possible to charge in step S904, the battery pack 300 is connected to the battery charger 100. Namely, connector connection is conducted between the battery charger 100 and the battery pack 300.

In step S910, the battery charger 100 determines whether a connector connection is made between the battery charger 100 and the battery pack 300. When it is determined that the connector connection is not made, the process goes back to step S908.

In step S912, when it is determined that the connector connection is made in step S910, the battery charger 100 checks the battery 306 of the battery pack 300 which is connector-connected.

In step S914, the battery charger 100 determines whether the battery 306 is normal.

In step S916, when it is determined that the battery 306 is not normal in step S914, the battery charger 100 reports that the battery 306 is not normal. In a viewpoint of surely reporting the fact that the battery 306 is not normal, it is preferable to use sound.

In step S918, the battery charger 100 determines whether the connector is removed. When it is determined that the connector is not removed, the process goes back to step S918. When it is determined that the connector is removed, the charging process ends.

In step S920, the battery charger 100 calculates the settable charging time and the charging amount (“C rate controller calculation 1”). The charging rate calculation section 1048 calculates the charging amount and the charging time to be reported to the user based on the information stored in the tag information register 1042 and the battery information register 1044.

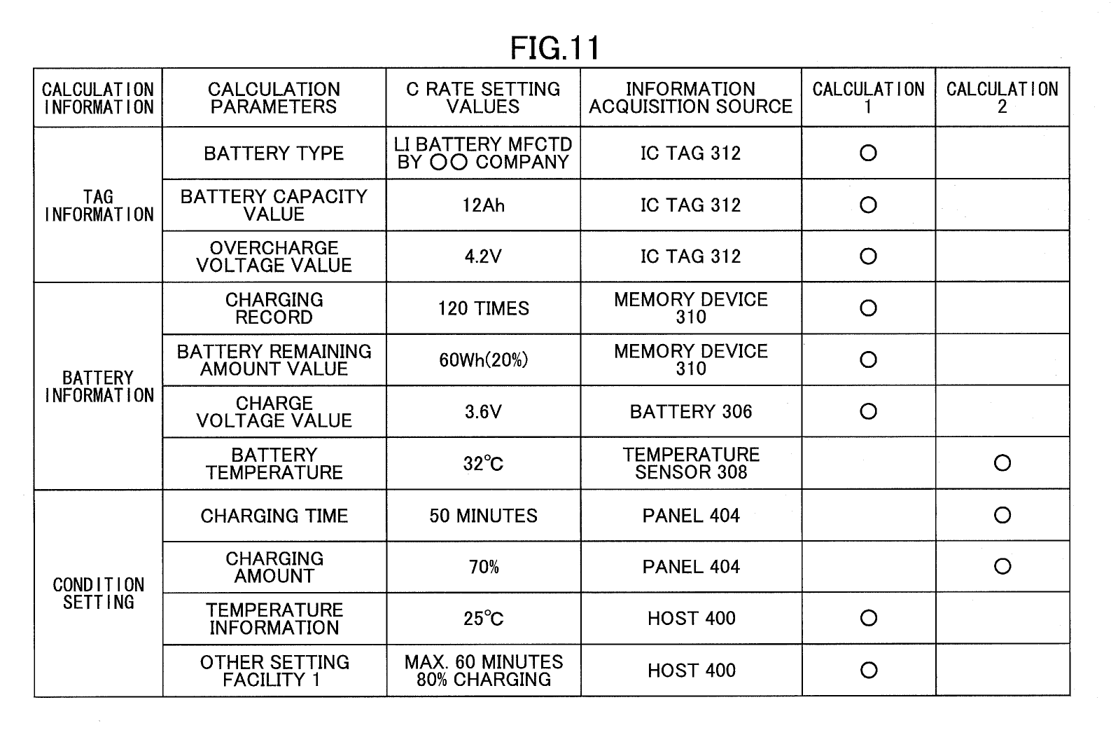

FIG. 11 shows an example setting of the charging rate.

As shown in FIG. 11, the information to be used in the calculation (calculation information), the C rate setting values, and the information acquisition source are associated with each other. Further, among the calculation information, the calculation information to be used in the “C rate controller calculation 1” and the calculation information to be use in the “C rate controller calculation 2” in step S926 are associated with each other.

The calculation information includes tag information, battery information, and setting condition (“condition setting”).

The tag information refers to the information acquired from the IC tag 312. The battery information refers to the information acquired from the battery pack 300. The condition setting refers to the information input via the control panel 110.

The tag information includes the battery type name (the product type name), the battery capacity value, and the overcharge voltage value.

The battery information includes the charging record, the battery remaining amount value, and a charge voltage value.

The condition setting includes the charging time, the charging amount, the environmental setting information such as, for example, the temperature information, and other setting. It is preferable that the environmental setting information includes not only the temperature information but also the maximum charging time, and the maximum charging power. The other setting includes facility information. Preferably, the other setting information, for example, includes the facility information of a supermarket and the like.

In the operations of the battery charging system according to an embodiment, the information acquisition source of the battery type name “Li battery manufactured by ∘∘ company” is the “IC tag 312”, and the battery type name is used in calculation 1. The information acquisition source of the battery capacity value “12 Ah” is the “IC tag 312”, and the battery capacity value is used in calculation 1. The information acquisition source of the overcharge voltage value “4.2 V” is the “IC tag 312”, and the overcharge voltage value is used in calculation 1. The information acquisition source of the charging record “120 times” is the “memory device 310”, and the charging record is used in calculation 1. The information acquisition source of the battery remaining amount value “60 Wh(20%)” is the “memory device 310”, and the charging record is used in calculation 1. The information acquisition source of the charge voltage value “3.6 V” is the “battery 306”, and the charge voltage value is used in calculation 1. The information acquisition source of a battery temperature “32° C.” is the “temperature sensor 308”, and the battery temperature is used in calculation 2. The information acquisition source of the charging time “50 minutes” is the “charging condition setting buttons 404 of the control panel 110”, and the charging time is used in calculation 2. The information acquisition source of the charging amount “70%” is the “charging condition setting buttons 404 of the control panel 110”, and the charging amount is used in calculation 2. The information acquisition source of the temperature information “25° C.” is the “host 400”, and the temperature information is used in calculation 1. The information acquisition source of the other setting “MAX. 60 minutes 80% charge” is the “host 400”, and the temperature information is used in calculation 1.

In the C rate controller calculation 1, the calculation to report the charging time and the charging amount to the user is performed.

For example, in an example of a supermarket, it is assumed to be possible to charge “80%” in “MAX. 60 minutes” at “facility 1” as other setting.

Based on the information, optimum values of the charging time and the charging amount are set as described below.

The charging rate calculation section 1048 assumes that the values of the charging time are 10 minutes, 20 minutes, 30 minutes, 40 minutes, 50 minutes, and 60 minutes, and calculates the corresponding values of the charging amount using the information which is necessary for the calculation 1.

For example, the charging rate calculation section 1048 calculates a power amount to be charged in the battery having 60 Wh (20%) remaining power (energy) as shown in FIG. 11 using a predetermined calculation formula based on all the parameters stored in the IC tag 312 the charging record, and the charge voltage value, and inputs (transmits) the power amount into the control section 106. As the calculation formula, various formulas may be used. The control section 106 displays the power amount input from the charging rate calculation section 1048 on the control panel 110. For example, 30%, 40%, 50%, 60%, 70%, and 80% of the power (energy) amount to be charged in the battery calculated by the charging rate calculation section 1048 are displayed on the control panel 110. Here, the power amount to be charged in the battery refers to the charge amount corresponding to the charging time.

In a case where the power (energy) 60 Wh (20%) remains, it is possible to set the values of the charge amount from 10 minutes up to maximum 60%.

A case is described where the battery 306 mounted on the electric bicycle is a Li battery. As shown in FIG. 7, the Li battery having 12 Ah can be charged from 0% to 100% with single-phase 100 V/1300 W in 24 minutes. Therefore, approximately 4% can be charged per minute. For further conveniences for the user, the charge amount to be charged may be set, for example, maximum 60%, 80%, 80%, 80%, 80%, and 80%.

Further, in a supermarket, etc., an appropriate charging amount to be charged may be set by taking the time period necessary for shopping and a profit of the supermarket into consideration. In step S922, as shown in part (3) of FIG. 10A, the battery charger 100 displays information prompting the user to select the charging time and the charging amount. In the example in part (3) of FIG. 10A, the charging time can be selected by using the charging condition setting button 404, so that the charging amount is set. In FIGS. 9 and 10, a case is described where the charging time “50 minutes” is selected. By selecting “50 minutes”, the corresponding charging amount “70%” is selected.

In step S924, the battery charger 100 determines whether any of the charging condition setting buttons 404 is selected. When determining that none of the charging condition setting buttons 404 is selected, the process goes back to step S922.

In step S926, when it is determined that any of the charging condition setting buttons 404 is selected in step S924, the battery charger 100 sets the charging condition in accordance with the selected charge time (“C rate controller calculation 2”). The charging rate calculation section 1048 calculates the C rate in accordance with the selected charge time.

In the C rate controller calculation 2, the calculation is performed for the charging condition when the charger 108 is controlled. When the charging time and the charging amount are selected, the charging rate calculation section 1048 calculates the charging condition when the charger 108 is controlled based on the environmental setting information such as, for example, temperature information set by the host 400 (e.g., 25° C.), a parameter when the battery temperature is 32° C., and the condition calculated by the “C rate controller calculation 1”. The condition calculated by the “C rate controller calculation 1” includes, for example, the condition set as the charging time is 50 minutes and the charge 70%.

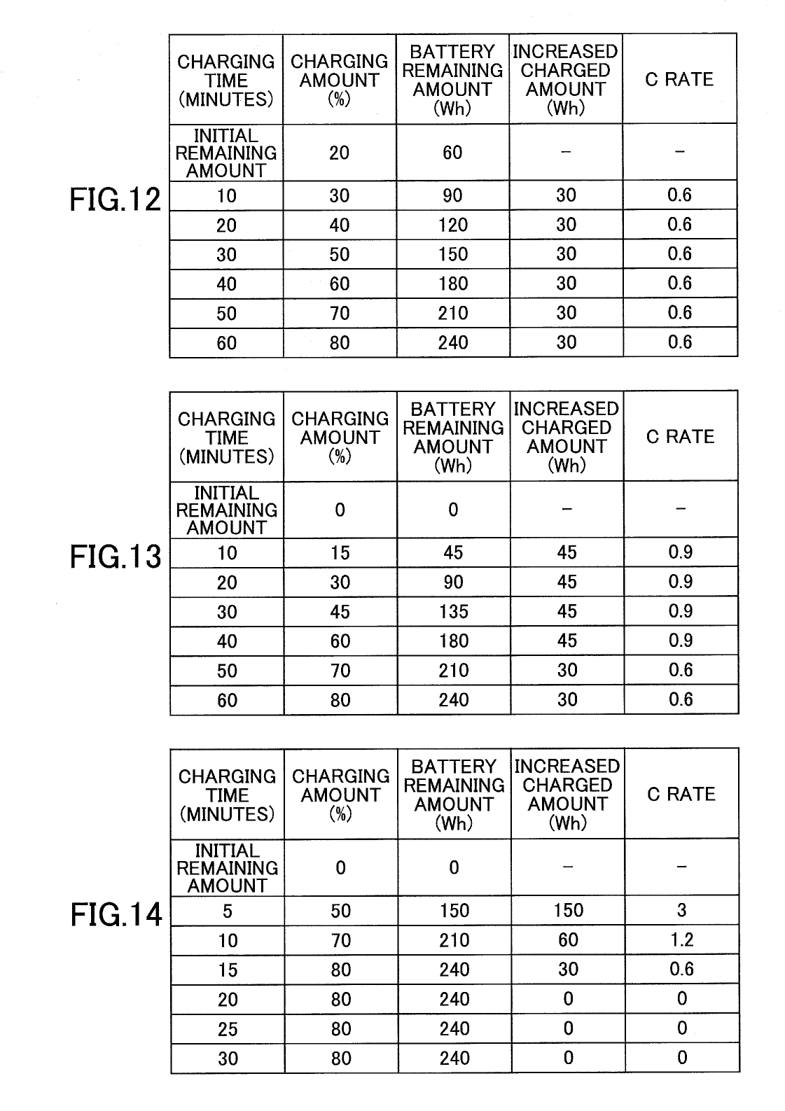

FIG. 12 shows an example of the C rate when the initial remaining amount, charging time, and charging amount are set as parameters. The specifications of the battery to be charged in FIG. 12 are 12 Ah, 7 cells, series, operating voltage 3.6 V, battery capacity maximum capacity 12 Ah×7 Cell×3.6 V [symbol] 300 Wh.

Here, according to the relationships among the charging amount, the charging time, and the C rate, the C rate to charge a 300 Wh battery in one hour is 1, the C rate to charge a 300 Wh battery in ten minutes is 6, and the C rate to charge 60 Wh battery in ten minutes is 1.2.

The charging rate calculation section 1048 inputs the C rate into the control signal processing section 1050. The control signal processing section 1050 inputs the control signal including the C rate into the control section 106. The control section 106 sets the charging condition to the charger 108 based on the control signal.

In step S928, the battery charger 100 causes the control panel 110 to display that charging is to be started as shown in part (4) of FIG. 10A.

In step S930, the battery charger 100 determines whether the charging start switch 406 is selected. When it is determined that the charging start switch 406 is not selected, the process goes back to step S928.

In step S932, the when it is determined that the charging start switch 406 is pressed, the battery charger 100 starts charging.

In step S934, the battery charger 100 causes the control panel 110 to display that charging is started as shown in part (5) of FIG. 10B.

In step S936, the battery charger 100 determines whether charging is finished.

In step S938, when the battery charger 100 determines that charging is finished, the battery charger 100 causes the control panel 110 to display that charging is finished as shown in part (6) of FIG. 10B.

In step S940, when the battery charger 100 determines that charging is not finished in step S936, the battery charger 100 causes the control panel 110 to display that charging is being performed as shown in part (7) of FIG. 10B.

In step S942, the battery charger 100 determines whether the charging stop switch 408 is pressed. When it is determined that the charging stop switch 408 is not selected, the process goes back to step S940.

In step S944, when it is determined that the charging stop switch 408 is pressed, the battery charger 100 measures the battery remaining amount.

In step S946, the battery charger 100 stops charging.

In step S948, the battery charger 100 causes the control panel 110 to display that charging is finished as shown in part (8) of FIG. 10B.

In an embodiment of the operations of the battery charging system, the initial remaining amount of the battery 306 is not limited to 20%. Similarly, the initial remaining amount may be any amount other than 20%.

FIG. 13 is a drawing showing an example of the C rate that is set by using the initial remaining amount, the charging time, the charging amount of the battery 306 as the parameters when the initial remaining amount of the battery 306 is 0%.

FIG. 14 is a drawing showing an example of the charging time and the charging amount that are set. FIG. 14 shows an example where it is assumed to charge 80% within 15 minutes. For example, it is assumed to charge the battery when a user comes by a convenience store or the like. According to FIG. 14, 80% charge is done in 15 minutes, but after that, 80% charge continues. The charging time and the charging amount can be set within a range that is supported by the battery charger 100.

Regarding the charging rate, it is preferable that two or more charging modes can be set. For example, a case is described where two charging modes are provided. However, more than two charging modes may be provided. For example, as the charging mode, the control panel 110 may display a “quick charging mode” and a “slow charging mode” that are selectable. Here, the charging rate in the “quick charging mode” is greater than a predetermined C rate. The charging rate in the “slow charging mode” is less than the C rate.

In the “slow charging mode”, a battery is charged slowly. So, it is preferable to display the “slow charging mode” along with a feature such as “better for battery service lifetime”, so that a user can consider to select it.

In the “quick charging mode”, charging is performed faster than in the “slow charging mode”. So, it is preferable to display the “quick charging mode” along with a feature such as “load may be applied to battery and not good for battery service lifetime, so select this for faster charging”, so that a user can consider to select it.

In accordance with the selected charging mode, the battery charger 100 displays the charging time and the charging amount which are calculated based on the greater C rate in the “quick charging mode” (i.e., faster charging mode), and displays the charging time and the charging amount which are calculated based on the lower C rate in the “slow charging mode” (i.e., slower charging mode). The user may refer to those charging times and the charging amounts to select the charging time.

The service lifetime of a secondary battery may become longer when the secondary battery is charged with the lower C rate. Therefore, when it is possible to take time to charge the battery, the service lifetime of the battery becomes longer by selecting the lower C rate. Further, it is possible to select the greater C rate to charge in a shorter time period. Therefore, the choices of a user can be increased.

Further, for a facility side installing the chargers, to prevent the concentration of the power consumption, it is preferable to disperse the charging amount. By dispersing the charging amount, the cost of a power supply facility may be reduced. Further, in a case where the chargers are installed in a shop, to increase the charging amount, it is preferable that the customers can take more time for shopping. By increasing the charge amount, it may become possible to increase the sales amount.

When two or more charging stands are provided, it is assumed that the total of the charging power amounts may exceed the power supply capability. It is preferable for an information processing apparatus such as the host 400 to monitor the total of the overall charging power amounts to determine whether the total of the charging power amounts exceeds the power supply capability. It is preferable that the host 400 gives instructions to the battery charger 100 to change the setting of the charging time and the charging amount displayed on the control panel 110, so that the total of the charging power amounts does not exceed the power supply capability. BY doing this, it becomes possible to optimize the facility cost and the power cost on the charging facility side.

In the battery charging system according to an embodiment, it is possible to provide the charging time and the charging amount in accordance with the settable charging rate based on the power source connected to the battery charger 100 and the battery capacity.

Further, the battery can be charged using the charging rate that is set based on the charging time and the charging rate. Further, it becomes possible to conduct optimum charging in accordance with a life style by registering the facility information based on the following scenes (e.g., the maximum (MAX) value of the charging time is registered as the supermarket facility information) as other information of the condition setting register 1046.

Specifically, it is assumed that the battery charger may be used in the following scenes.

When the battery charger is installed in a house, a scene is assumed in which a single-phase 100 V power outlet is used and approximately 80% charging is performed from when a user gets up to when the user leaves home (within approximately 30 minutes).

When the battery charger is installed as the charging stand in a convenience store, a scene is assumed in which approximately 80% charging is performed during 10-minute shopping.

When the battery charger is installed as the charging stand in a supermarket, a scene is assumed in which approximately 80% charging is performed during 10 to 30-minute shopping.

When the battery charger is installed as the charging stand in a large commercial facility, a scene is assumed in which approximately 80% charging is performed during 30 to 120-minute shopping.

When the battery charger is installed as the charging stand in a bicycle-parking area, a scene is assumed in which charging is performed by taking a long time.

As described above, by making it possible to select charging time and the charging amount, it becomes possible to improve the convenience for users.

### Second Embodiment

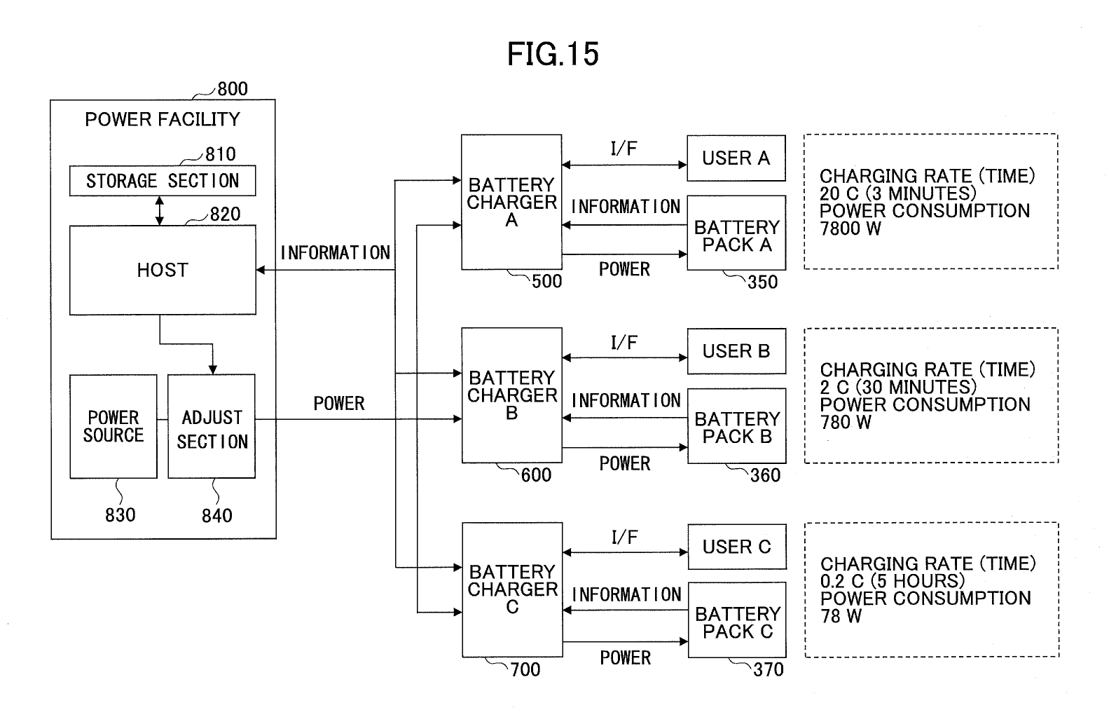

FIG. 15 is a drawing showing an electric bicycle charging station according to an embodiment. The electric bicycle charging station includes two or more charging stands.

The electric bicycle charging station includes a battery charger A 500, a battery charger B 600, a battery charger C 700, and a power facility 800. The electric bicycle charging station may include one or two battery chargers or may include four or more battery chargers.

The battery charger described with reference to FIG. 2 is applied to the battery charger A 500, the battery charger B 600, and the battery charger C 700. However, the control section 106 transmits the charge information such as the C rate information from the charging rate setting section 104 to a host 820 via the communication section 112.

FIG. 15 shows a case where power of 390 W is required per 1 C for charging the battery pack.

The charging time of the battery pack corresponding to the charging rate 20 C is three minutes. Then, the power consumption of the battery charger is 7800 W per minute.

The charging time of the battery pack corresponding to the charging rate 2 C is thirty minutes. Then, the power consumption of the battery charger is 780 W per minute.

The charging time of the battery pack corresponding to the charging rate 0.2 C is five hours. Then, the power consumption of the battery charger is 78 W per minute.

The power facility 800 is a power supply apparatus and includes a storage section 810, the host 820, a power source 830, and an adjust section 840.

The storage section 810 stores the maximum power supply amount of the power facility 800. Further, the storage section 810 stores schedule information indicating the power amounts to be supplied to the battery charger A 500, the battery charger B 600, and the battery charger C 700 per unit time and generated by the host 820 when the battery packs, which are connected to the battery charger A 500, the battery charger B 600, and the battery charger C 700, are charged.

The host 820 is connected to the storage section 810. When connected to the battery packs, the battery charger A 500, the battery charger B 600, and the battery charger C 700 calculate and report the C rates to the host 820. The host 820 performs scheduling acquiring the power amounts to be supplied to the battery chargers per unit time based on the C rates from the battery chargers. The host 820 inputs the scheduling information into the adjust section 840.

The power source 830 charges the battery packs connected to the battery chargers.

The adjust section 840 is connected to the host 820 and the power source 830. The adjust section 840 adjusts the total power amount to be supplied to the battery chargers. Namely, the adjust section 840 adjusts the total amount of power requested from the battery chargers. The adjust section 840 adjusts the total amount of power requested from the battery chargers based on the scheduling information from the host 820. Further, for example, in a case where power is supplied to the battery chargers as the capability of the power source 830 (e.g., 1000 W or less) to preferentially supply power to a convenience store, the adjust section 840 may adjust the total amount value of the power that can be supplied.

### Charge Scheduling of Electric Bicycle Charging Station

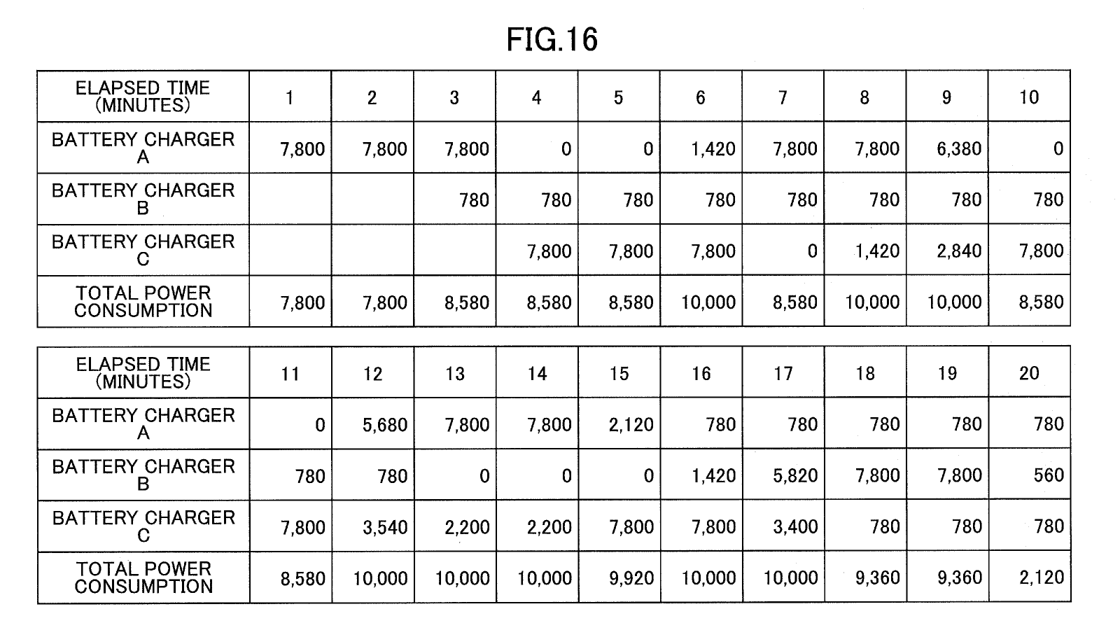

FIG. 16 is a drawing showing an example of a charging schedule when charging is performed in the electric bicycle charging station of FIG. 15. The charge scheduling is performed by the host 820. The host 820 functions as a scheduling section. FIG. 16 shows the relationship between the elapsed time since the electric bicycle is connected to the battery chargers, the power consumption of the battery chargers per unit time, and the total power consumption per unit time consumed by the power facility 800.

In the electric bicycle charging station according to an embodiment, the power source 830 outputs the maximum power of 10000 W and charge service time can be set within 10 minutes regardless of the charging rate of the battery charger. Therefore, even when the battery cannot be fully charged due to low charging rate in the 10-minute charging, the charging is stopped at that time. As the charge service time, various kinds of settings are possible. The storage section 810 stores 10000 W as the maximum power supply amount. For example, the electric bicycle charging station according to an embodiment may be installed in a position where many users can use it such as a convenience store.

In the electric bicycle charging station according to an embodiment, the battery pack corresponding to the charging rate 2 C or the battery pack corresponding to the charging rate 20 C is connected to the battery charger A 500, the battery charger B 600, and the battery charger C 700. This case is also applied to the case where the battery pack having a different charging rate is connected.

In the example of FIG. 16, the initial battery remaining amount of the electric bicycle connected to the electric bicycle charging station is 0%. The present invention is not limited to this case, and may be applied to a case where initial battery remaining amount of the electric bicycle connected to the electric bicycle charging station is other than 0%. In this case, the battery chargers acquires the information indicating the settable charging time and the charging amount based on the battery remaining amount. For example, when the battery pack corresponding to the charging rate 2 C is connected to the battery charger and the battery pack has a certain battery remaining amount, charging may be finished less than three minutes. Therefore, wait time for charging may be reduced.

Explanations are described with reference to FIG. 16.

A battery pack corresponding to the charging rate 20 C is connected to the battery charger A 500. The host acquires the power amounts to be supplied to the battery chargers per unit time based on the maximum power supply amount stored in the storage section 810 and the C rate information from the battery charger A 500. Here, it is assumed that the unit time is one minute. However, the unit time such as thirty seconds or two minutes may be set to the time as a unit of scheduling.

A battery pack corresponding to the charging rate 20 C is connected to the battery charger A 500, but no battery pack is connected to the battery charger B 600 and the battery charger C 700. Further, when it is assumed that the charging rate is 20 C, the power consumption per unit time is 7800 W which is less than the maximum power supply amount. Therefore, the host 820 performs scheduling so that power of 7800 W is supplied for when the elapsed time is one through three minutes.

When the elapsed time is 3 minutes, while a battery pack corresponding to the charging rate 20 C is connected to the battery charger A 500, a battery pack corresponding to the charging rate 2 C is connected to the battery charger B 600.

The host 820 acquires the power amount that can be supplied to the battery pack connected to the battery charger B 600 from 2200 W which is determined by subtracting the power consumption 7800 W of the battery charger A 500 per unit time from the maximum power supply amount 10000 W. Namely, power is preferentially supplied to the battery pack that is connected earlier and scheduling this time is performed based on a result of the scheduling previously performed. Instead of placing the priority on the battery pack that is connected earlier, charging using any of the battery charger A 500, the battery charger B 600, and the battery charger C 700 is set for a service for a price and the higher priority is placed on the battery charger that provides the charging service for the price.

A battery corresponding to the charging rate 2 C is connected. The power consumption per unit time in the case of the charging rate 2 C is 780 W, which is less than 2200 W which. Therefore, in the elapsed time of 10 minutes from 3 minutes to 12 minutes, the host 820 performs scheduling so that power of 780 W is supplied to the battery charger B 600.

When the elapsed time is 4 minute, charging of the battery pack corresponding to the charging rate 20 C connected to the battery charger A 500 is finished. When the elapsed time is 4 minutes, while the battery pack corresponding to the charging rate 2 C is connected to the battery charger B 600, a battery pack corresponding to the charging rate 20 C is connected to the battery charger C 700.

The host 820 acquires the power amount that can be supplied to the battery pack connected to the battery charger C 700 from 9220 W which is determined by subtracting the energy (power) consumption 780 W of the battery charger B 600 from the maximum power supply amount 10000 W. A battery pack corresponding to the charging rate 20 C is connected to the battery charger C 700. The power consumption in the case of the charging rate 20 C is 7800 W, which is less than 9220 W. Therefore, in the elapsed time from 4 minutes to 6 minutes, the host 820 performs scheduling so that power 7800 W is supplied to the battery charger C 700.

When the elapsed time is 6 minutes, while the battery pack corresponding to the charging rate 2 C is connected to the battery charger B 600 and the battery pack corresponding to the charging rate 20 C is connected to the battery charger C 700, a battery pack corresponding to the charging rate 20 C is connected to the battery charger A 500.

The host 820 acquires the power amount that can be supplied to the battery pack connected to the battery charger A 500 from 1420 W which is determined by subtracting the power consumption 780 W of the battery charger B 600 and the power consumption 7800 W of the battery charger C 700 from the maximum power supply amount 10000 W. A battery pack corresponding to the charging rate 20 C is connected to the battery charger A 500. The power consumption in the case of the charging rate 20 C is 7800 W, which is greater than 1420 W. Therefore, in the elapsed time of 6 minutes, since only power 1420 W can be supplied to the battery charger A 500, the host 820 performs scheduling so that power 1420 W is supplied to the battery charger A 500.

When the elapsed time is 7 minutes, charging of the battery pack corresponding to the charging rate 20 C connected to the battery charger C 700 is finished. When the elapsed time is 7 minute, a battery pack corresponding to the charging rate 2 C is connected to the battery charger B 600 and a battery pack corresponding to the charging rate 20 C is connected to the battery charger A 500.

The host 820 acquires the power amount that can be supplied to the battery pack connected to the battery charger A 500 from 9220 W which is determined by subtracting the power consumption 780 W of the battery charger B 600 per unit time from the maximum power supply amount 10000 W. A battery pack corresponding to the charging rate 20 C is connected to the battery charger A 500. The power consumption in the case of the charging rate 20 C is 7800 W, which is less than 9220 W. Therefore, in the elapsed time of 7 minutes, the host 820 performs scheduling so that power 7800 W is supplied to the battery charger A 500.

When the elapsed time is 8 minutes, while the battery pack corresponding to the charging rate 2 C is connected to the battery charger B 600 and the battery pack corresponding to the charging rate 20 C is connected to the battery charger A 500, a battery pack corresponding to the charging rate 20 C is connected to the battery charger C 700.

The host 820 acquires the power amount that can be supplied to the battery pack connected to the battery charger C 700 from 1420 W which is determined by subtracting the power consumption 780 W of the battery charger B 600 and the power consumption 7800 W of the battery charger A 500 from the maximum power supply amount 10000 W. A battery pack corresponding to the charging rate 20 C is connected to the battery charger C 700. The power consumption in the case of the charging rate 20 C is 7800 W, which is greater than 1420 W. Therefore, in the elapsed time of 8 minutes, since only power 1420 W can be supplied to the battery charger C 700, the host 820 performs scheduling so that power 1420 W is supplied to the battery charger C 700.

When the elapsed time is 9 minutes, battery packs corresponding to the charging rates 20 C, 2 C, and 20 C are connected to the battery charger A 500, the battery charger B 600, and the battery charger C 700, respectively. The host 820 performs scheduling so that power 6380 W is supplied to the battery pack corresponding to the charging rate 20 C and being connected to the battery charger A 500, the power 6380 W being determined by subtracting power 1420 W, which is supplied when the elapsed time is 6 minutes, from power 7800 W which is supplied in one minute. Further, the host 820 acquires the power amount that can be supplied to the battery pack connected to the battery charger C 700 from 2840 W which is determined by subtracting the power consumption 6380 W of the battery charger A 500 and the power consumption 780 W of the battery charger B 600 from the maximum power supply amount 10000 W. A battery pack corresponding to the charging rate 20 C is connected to the battery charger C 700. The power consumption in the case of the charging rate 20 C is 7800 W, which is greater than 2840 W. Therefore, in the elapsed time of 9 minute, since only power 2840 W can be supplied to the battery charger C 700, the host 820 performs scheduling so that power 2840 W is supplied to the battery charger C 700.

When the elapsed time is 10 minutes, charging of the battery pack corresponding to the charging rate 20 C connected to the battery charger A 500 is finished. When the elapsed time is 10 minutes, a battery pack corresponding to the charging rate 2 C is connected to the battery charger B 600 and a battery pack corresponding to the charging rate 20 C is connected to the battery charger C 700.

The host 820 acquires the power amount that can be supplied to the battery pack connected to the battery charger C 700 from 9220 W which is determined by subtracting the power consumption 780 W of the battery charger B 600 from the maximum power supply amount 10000 W. A battery pack corresponding to the charging rate 20 C is connected to the battery charger C 700. The power consumption in the case of the charging rate 20 C is 7800 W, which is less than 9220 W. Therefore, in the elapsed time of 10 minutes, the host 820 performs scheduling so that power 7800 W is supplied to the battery charger C 700.

The scheduling when the elapsed time is 10 minutes can also be applied to the scheduling when the elapsed time is 11 minutes.

When the elapsed time is 12 minutes, while the battery pack corresponding to the charging rate 2 C is connected to the battery charger B 600 and the battery pack corresponding to the charging rate 20 C is connected to the battery charger C 700, a battery pack corresponding to the charging rate 20 C is connected to the battery charger A 500.

The host 820 performs scheduling so that power 3540 W is supplied to the battery pack corresponding to the charging rate 20 C and being connected to the battery charger C 700, the power 3450 W being determined by subtracting power 1420 W and 2840 W, which are supplied when the elapsed time is 8 minutes and 9 minutes, respectively, from power 7800 W which is supplied in the one minute. Further, the host 820 acquires the power amount that can be supplied to the battery pack connected to the battery charger A 500 from 5680 W which is determined by subtracting the power consumption 780 W of the battery charger B 600 and the power consumption 3540 W of the battery charger C 700 from the maximum power supply amount 10000 W. A battery pack corresponding to the charging rate 20 C is connected to the battery charger A 500. The power consumption in the case of the charging rate 20 C is 7800 W, which is greater than 5680 W. Therefore, in the elapsed time of 12 minutes, since only power 5680 W can be supplied to the battery charger A 500, the host 820 performs scheduling so that power 5680 W is supplied to the battery charger A 500.

When the elapsed time is 13 minutes, charging of the battery pack corresponding to the charging rate 2 C connected to the battery charger B 600 is finished. When the elapsed time is 13 minute, a battery pack corresponding to the charging rate 2 C is connected to the battery charger A 500 and a battery pack corresponding to the charging rate 2 C is connected to the battery charger C 700.

The host 820 acquires the power amount that can be supplied to the battery pack connected to the battery charger A 500 from 9220 W which is determined by subtracting the power consumption 780 W of the battery charger B 600 from the maximum power supply amount 10000 W. A battery pack corresponding to the charging rate 20 C is connected to the battery charger A 500. The power consumption in the case of the charging rate 20 C is 7800 W, which is less than 9220 W. Therefore, in the elapsed time of 13 minute, the host 820 performs scheduling so that power 7800 W is supplied to the battery charger A 500.

The scheduling when the elapsed time is 13 minutes can also be applied to the scheduling when the elapsed time is 14 minutes.

When the elapsed time is 15 minutes, a battery pack corresponding to the charging rate 20 C is connected to the battery charger A 500 and a battery pack corresponding to the charging rate 20 C is connected to the battery charger C 700. The host 820 performs scheduling so that power 2120 W is supplied to the battery pack corresponding to the charging rate 20 C and being connected to the battery charger A 500, the power 2120 W being determined by subtracting power 1420 W and 1680 W, which are supplied when the elapsed time is 12 minutes, from power 7800 W which is supplied in the one minute. Further, the host 820 acquires the power amount that can be supplied to the battery pack connected to the battery charger C 700 from 7880 W which is determined by subtracting the power consumption 2120 W of the battery charger A 500 and from the maximum power supply amount 10000 W. A battery pack corresponding to the charging rate 20 C is connected to the battery charger C 700. The power consumption in the case of the charging rate 20 C is 7800 W, which is less than 7880 W. Therefore, in the elapsed time of 15 minute, the host 820 performs scheduling so that power 7800 W is supplied to the battery charger C 700.

When the elapsed time is 16 minutes, while the battery pack corresponding to the charging rate 20 C is connected to the battery charger C 700, a battery pack corresponding to the charging rate 2 C is connected to the battery charger A 500 and a battery pack corresponding to the charging rate 20 C is connected to the battery charger B 600. The host 820 supplies power 2200 W, which is determined by subtracting the power consumption 7800 W from the maximum power supply amount 10000 W, to the battery packs corresponding to the charging rate 2 C and 20 C connected to the battery chargers A 500 and B 600, respectively. As the electric bicycle charging station according to an embodiment, a case is described where power is preferentially supplied in the order of the battery charger A 500, the battery charger B 600, and the battery charger C 700. It is preferable that the order of the battery chargers to which power is preferentially supplied is determined in advance.

A battery pack corresponding to the charging rate 2 C is connected to the battery charger A 500. The power consumption in the case of the charging rate 2 C is 780 W, which is less than 2200 W. Therefore, in the elapsed time of 16 minutes, the host 820 performs scheduling so that power 780 W is supplied to the battery charger A 500. Further, the host 820 acquires the power amount that can be supplied to the battery pack connected to the battery charger B 600 from 1420 W which is determined by subtracting the power consumption 780 W of the battery charger A 500 and the power consumption 7800 W of the battery charger C 700 from the maximum power supply amount 10000 W. A battery pack corresponding to the charging rate 20 C is connected to the battery charger B 600. The power consumption in the case of the charging rate 20 C is 7800 W, which is greater than 1420 W. Therefore, in the elapsed time of 16 minutes, since only power 1420 W can be supplied to the battery charger B 600, the host 820 performs scheduling so that power 1420 W is supplied to the battery charger B 600.

When the elapsed time is 17 minutes, the battery packs corresponding to the charging rates 2 C, 20 C, and 20 C are connected to the battery charger A 500, the battery charger B 600, and the battery charger C 700, respectively. The host 820 performs scheduling so that power 3400 W is supplied to the battery pack corresponding to the charging rate 20 C and being connected to the battery charger C 700, the power 3400 W being determined by subtracting power 2200 W and 2200 W, which are supplied when the elapsed time is 13 minutes and 14 minutes, respectively, from power 7800 W which is supplied in the one minute. Further, the host 820 acquires the power amount that can be supplied to the battery pack connected to the battery charger B 600 from 5820 W which is determined by subtracting the power consumption 780 W of the battery charger A 500 and the power consumption 3400 W of the battery charger C 700 from the maximum power supply amount 10000 W. A battery pack corresponding to the charging rate 20 C is connected to the battery charger B 600.

The power consumption in the case of the charging rate 20 C is 7800 W, which is greater than 5820 W. Therefore, in the elapsed time of 17 minutes, since only power 5820 W can be supplied to the battery charger B 600, the host 820 performs scheduling so that power 5820 W is supplied to the battery charger B 600.

When the elapsed time is 18 minutes, charging of the battery pack corresponding to the charging rate 20 C connected to the battery charger C 700 is finished. When the elapsed time is 18 minutes, while the battery pack corresponding to the charging rate 2 C is connected to the battery charger A 500 and the battery pack corresponding to the charging rate 20 C is connected to the battery charger B 600, a battery pack corresponding to the charging rate 2 C is newly connected to the battery charger C 700.

The host 820 acquires the power amount that can be supplied to the battery pack connected to the battery charger B 600 from 9220 W which is determined by subtracting the power consumption 780 W of the battery charger A 500 from the maximum power supply amount 10000 W. A battery pack corresponding to the charging rate 20 C is connected to the battery charger B 600. The power consumption in the case of the charging rate 20 C is 7800 W, which is less than 9220 W. Therefore, in the elapsed time of 18 minutes, the host 820 performs scheduling so that power 7800 W is supplied to the battery charger B 600. Further, the host 820 acquires the power amount that can be supplied to the battery pack connected to the battery charger C 700 from 1420 W which is determined by subtracting the power consumption 780 W of the battery charger A 500 and the power consumption 7800 W of the battery charger B 600 from the maximum power supply amount 10000 W. A battery pack corresponding to the charging rate 20 C is connected to the battery charger C 700. The power consumption in the case of the charging rate 2 C is 780 W, which is less than 1420 W. Therefore, in the elapsed time of 18 minutes, the host 820 performs scheduling so that power 780 W is supplied to the battery charger C 700.

The scheduling when the elapsed time is 18 minutes can also be applied to the scheduling when the elapsed time is 19 minutes.

When the elapsed time is 20 minutes, the battery packs corresponding to the charging rates 2 C, 20 C, and 2 C are connected to the battery charger A 500, the battery charger B 600, and the battery charger C 700, respectively. The host 820 acquires the power amount that can be supplied to the battery pack connected to the battery charger B 600 from 9220 W which is determined by subtracting the power consumption 780 W of the battery charger A 500 from the maximum power supply amount 10000 W.

The host 820 performs scheduling so that power 560 W is supplied to the battery pack corresponding to the charging rate 20 C and being connected to the battery charger B 600, the power 560 W being determined by subtracting power 1420 W and 5820 W, which are supplied when the elapsed time is 16 minutes and 17 minutes, respectively, from power 7800 W which is supplied in the one minute. Further, the host 820 acquires the power amount that can be supplied to the battery pack connected to the battery charger C 700 from 8660 W which is determined by subtracting the power consumption 780 W of the battery charger A 500 and the power consumption 560 W of the battery charger B 600 from the maximum power supply amount 10000 W. A battery pack corresponding to the charging rate 2 C is connected to the battery charger C 700. The power consumption in the case of the charging rate 2 C is 780 W, which is less than 8660 W. Therefore, in the elapsed time of 20 minutes, the host 820 performs scheduling so that power 780 W is supplied to the battery charger C 700.

In the example scheduling described above, the host 820 may store a result of scheduling per unit time into the storage section 810 and report the result of scheduling per unit time to the battery chargers. The battery chargers may display the result of scheduling on the control panels 110. By doing this, it becomes possible to notify the charging time and the charging amount.

Further, in the above scheduling example, energy may be supplied to the battery chargers within the respective charging rate ranges corresponding to the battery packs.

### Modified Example

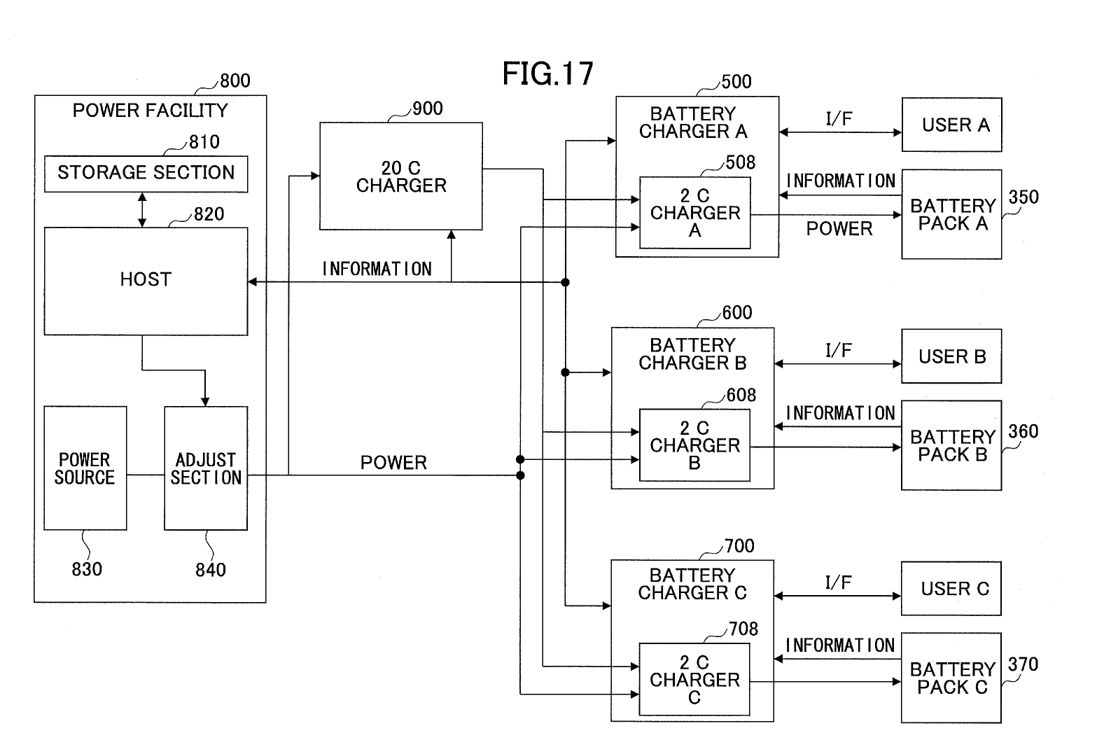

FIG. 17 is a drawing showing a modified example of the electric bicycle charging station. The electric bicycle charging station includes two or more charging stands.

Similar to the electric bicycle charging station described with reference to FIG. 15, the electric bicycle charging station in this modified example includes the battery charger A 500, the battery charger B 600, the battery charger C 700, and the power facility 800. The battery charger A 500, the battery charger B 600, and the battery charger C 700 include a charger A 508, a charger B 608, and a charger C 708, respectively.

The charger A 508, the charger B 608, and the charger C 708 correspond to charging rate 2 C. Namely, the charger A 508, the charger B 608, and the charger C 708 are capable of changing the C rate up to 2 C by a calculation process based on the state of the battery pack 300.

The electric bicycle charging station may include one or two battery chargers or four or more battery chargers.

The electric bicycle charging station further includes a charger 900. The charger 900 is connected to the power facility 800, the battery charger A 500, the battery charger B 600, and the battery charger C 700.

The charger 900 corresponds to the charging rate 20 C. Namely, the charger 900 can change the C rate up to 20 C by a calculation process based on a state of the battery pack 300. For example, when a battery pack 300 corresponding to 10 C is connected, the charger 900 can performs the calculation process so as to charge at 10 C.

Before a battery pack corresponding to 20 C becomes popular, it is expected that the charger corresponding to 20 C will also not be popular. Therefore, it is desired that the battery chargers include the chargers (the charger A 508, the charger B 608, and the charger C 708) corresponding to the charging rate up to 2 C, and share the use of the charger 900 corresponding to the charging rate up to 20 C.

A case is described where a battery pack corresponding to the charging rate 20 C is connected to the battery charger and energy (power) is supplied to the battery pack as a result of scheduling.

The host 820 inputs a switching signal to switch to the battery charger, among the charger A 508, a charger B 608, and a charger C 708, connected to the battery pack corresponding to the charging rate 20 C so as to supply power from the power source 830 to the battery pack. Further, the host 820 controls the adjust section 840 so that power from the power source 830 is supplied to the charger 900. As a result, power from the power source 830 is supplied to the battery pack corresponding to the charging rate 20 C via the charger 900.

As the battery charger A 500, the battery charger B 600, and the battery charger C 700, the battery charger 100 described with reference to FIG. 2 may be used. However, the control section 106 transmits the information of the settable charging time and the charging amount and C rate information to the host 820 via the communication section 112.

As the power facility 800, the power facility described with reference to FIG. 15 may be used.

In the electric bicycle charging station in one modified example, by having one charger corresponding to the charging rate 20 C, it becomes possible to charge the battery pack of the electric bicycles installed at two or more electric bicycle charging stations. Therefore, it becomes possible to reduce the cost and size of the installation area when compared with the case where both the charger corresponding the charging rate 20 C and the charger corresponding the charging rate 2 C are provided.

It is expected the number of the electrically-movable objects (electrically movable bodies) such as the electric bicycles will increase. With the increase in the number of the electrically-movable objects, the charging facilities to supply power to the electrically-movable objects are expected to play an important roll in the future. In view of the conveniences of the charging facility, it is preferable that the charging facility is installed in public facilities, parking lots for vehicles and bicycles, convenience stores, supermarkets, and large commercial facilities.

Further, the number of the batteries capable of being quickly charged is expected to be increased. However, even when such batteries capable of being quickly charged are developed, it is assumed that it takes time for the movable objects using the batteries to become popular. Therefore, it may be desired to provide a means to support their promotions.

According to the embodiments and modified example described above, by using the power facility and the battery chargers, it may become possible to improve the user convenience. Therefore, it may become possible to prevail and promote the electrically-movable objects.

The present invention is described above by referring to a specific embodiment. However, the above embodiment is described for illustrative purpose only, and a person skilled in the art may think of examples of various modifications, transformations, alterations, changes, and the like. To promote an understanding of the present invention, the specific values are used as examples throughout the description. However, it should be noted that such specific values are just sample values unless otherwise described, and any other appropriate values may be used. Further, it should be noted that the division of the embodiments and the items is not essential to the present invention. For example, two or more embodiments or items may be combined on an as-needed basis, and an item described in an embodiment or an item may be applied to another embodiment or item as long as it is not contradictory. For illustrative purposes, the apparatus according to an embodiment of the present invention is described with reference to the functional block diagram. However, such an apparatus may be provided by hardware, software, or a combination thereof. The present invention is not limited to the embodiments described above, and various modifications, transformations, alteration, exchanges, and the like may be made without departing from the scope and spirit from the present invention.

The present application is based on and claims the benefit of priority of Japanese Patent Application Nos. 2012-288016 filed on Dec. 28, 2012 and 2013-250923 filed on Dec. 4, 2013, the entire contents of which are hereby incorporated herein by reference.

### DESCRIPTION OF THE REFERENCE NUMERALS

100: BATTERY CHARGER
102: NEAR FIELD COMMUNICATION SECTION
104: CHARGING RATE SETTING SECTION
106: CONTROL SECTION
108: CHARGER
110: CONTROL PANEL
112: COMMUNICATION SECTION
120: CHARGE INFORMATION LINE
130: CHARGE POWER LINE
150: COMMERCIAL POWER SOURCE
200: COMMUNICATION NETWORK
300: BATTERY PACK
302: CHARGE/DISCHARGE CONTROL SECTION
304: REMAINING AMOUNT DETECTING CIRCUIT
306: BATTERY
308: TEMPERATURE SENSOR
310: MEMORY DEVICE
312: IC TAG
350: BATTERY PACK A
360: BATTERY PACK B
370: BATTERY PACK C
400: HOST
500: BATTERY CHARGER A
508: CHARGER A
600: BATTERY CHARGER B
608: CHARGER B
700: BATTERY CHARGER A
708: CHARGER B
800: POWER FACILITY
810: STORAGE SECTION
820: HOST
830: POWER SOURCE
840: ADJUST SECTION
900: CHARGER

### PRIOR-ART DOCUMENT

### Patent Document

[Patent Document 1] Japanese Laid-Open Patent Application No. 2001-211554

1. A battery charger for charging a battery, the battery charger comprising,
a charger;
an acquisition unit configured to acquire information of the battery; and
a control unit configured to set a charging condition of the battery based on the information of the battery and control the charger.

2. The battery charger according to claim 1,
wherein the control unit is configured to perform control to display the charging condition settable based on the information of the battery and set the charging condition input by a user.

3. The battery charger according to claim 1,
wherein the control unit is configured to perform control to display two or more of the charging conditions, where charging rates are different from each other, based on the information of the battery.

4. The battery charger according to claim 1,
wherein the control unit is configured to perform control to display a charging condition settable based on environmental setting information and set the charging condition input by a user.

5. The battery charger according to claim 4,
wherein the environmental setting information includes temperature information, maximum charging time, or maximum charging power.

6. The battery charger according to claim 5, further comprising:
an information processing apparatus configured to monitor charging power amounts of two or more of the battery chargers and set the environmental setting information based on the charging power amounts,
wherein the control unit is configured to perform control to display a charging condition settable based on environmental setting information set by the information processing apparatus.

7. The battery charger according to claim 1,
wherein the acquisition unit is configured to acquire information of the battery using a near field communication technique.

8. The battery charger according to claim 1,
wherein the information of the battery includes a battery type name, a battery capacity value, or a battery remaining amount.

9. The battery charger according to claim 1,
wherein the charging condition includes charging time or charging amount.

10. (canceled)

11. A battery charging method for charging a battery, the method comprising:
acquiring information of the battery;
setting a charging condition of the battery based on the information of the battery; and
controlling the charger.

12. A battery charging system comprising:
two or more battery chargers configured to charge batteries at charging rates in accordance with types of the batteries; and
a power supply apparatus configured to supply power to the battery chargers,
wherein the battery chargers include
an acquisition unit configured to acquire the types of the batteries connected to the battery chargers,
a charging rate setting unit configured to set the charging rates in accordance with the batteries based on the types of the batteries,
a control unit configured to control chargers to charge at the charging rates set by the charging rate setting unit, and
a communication unit configured to send the charging rates set by the charging rate setting unit to the power supply apparatus,
wherein the power supply apparatus includes
a storage unit configured to store a maximum value of a power amount supplied by the power supply apparatus,
a scheduling unit configured to perform scheduling that acquires power amounts to be supplied to the battery chargers per unit time based on the maximum value of the power amount stored in the storage unit and the charging rates sent from the battery chargers, and
an adjusting unit configured to adjust a total amount of power to be supplied to the battery chargers based on the scheduling performed by the scheduling unit.

13. A battery charging system according to claim 12,
wherein the scheduling unit is configured to, when a charging rate is newly reported from a battery charger, acquire a power amount to be supplied to the battery charger newly reported the charging rate based on the maximum value of the power amount stored in the storage unit and the power amounts supplied in a previous scheduling.
